(19) United States
(12) Patent Application Publication
(10) Pub. No.: US 2018/0075557 A1
(43) Pub. Date: Mar. 15, 2018

(54) Digital Hall Pass System

(71) Applicant: Zachary Adam Baker, Noblesville, IN (US)

(72) Inventor: Zachary Adam Baker, Noblesville, IN (US)

(21) Appl. No.: 15/355,699

(22) Filed: Nov. 18, 2016

Related U.S. Application Data
(60) Provisional application No. 62/256,807, filed on Nov. 18, 2015.

(51) Int. Cl. G06Q 50/20; G06Q 10/06; H04W 4/12

(52) U.S. Cl. CPC G06Q 50/205; H04W 4/12; G06Q 10/06

(57) ABSTRACT

A system and method for requesting, validating, and monitoring hall passes digitally.

### CROSS-REFERENCE TO RELATED APPLICATIONS

The present application claims the benefit of U.S. Provisional Patent Application No. 62/256,807 to Shelton, entitled “Digital Hall Pass System”, and filed on Nov. 18, 2016, which is hereby incorporated by reference in its entirety.

### BACKGROUND OF THE DISCLOSURE

For decades primary school teachers have used hall passes as a permit for students to do selective tasks during class time outside of their normally assigned classrooms. Traditionally, teachers have issued paper hall passes to students to authorize students to perform tasks such as travelling to and from restrooms, visiting other teachers' classrooms or administrative offices, etc.

Historically, the time-consuming process of issuing a paper hall pass has drawbacks such as student theft of passes from teachers and administrators, unauthorized duplication, and forgeries. Ultimately, this created a teacher and administrative burdens in protecting paper hall passes and monitoring their distribution.

### SUMMARY OF THE DISCLOSURE

The present disclosure relates to a system and method for using portable devices that functions as a digital hall pass system. The disclosed system and method comprises of an application for students requesting hall passes, an application for teacher approval or denial of hall passes, and an overall administrative application.

The present disclosure can be implemented in a variety of embodiments including but not limited to computers and/or mobile devices that utilize Apple®, Android®, or Windows® operating systems. Additionally, the present disclosure can be implemented via web servers and other web based operating system platforms.

Referring to the present disclosure, a system and method is provided including a process of requesting a hall passes and their acceptance, rejection, and tracking of hall passes. Additionally, the process preferably allows teachers to monitor the time at which a student left a classroom and the time the student returned to the classroom.

Additional features of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The aforementioned aspects and many of the intended features of this disclosure will grow to be appreciated at a greater level once references to the following accompanying illustrations are expounded upon.

FIG. 1 is an overall view of a digital hall pass system which includes hand-held devices for students, teachers, and administrators and a mobile application server that includes a mobile management database for storing data;

FIG. 2 is a block diagram that illustrates a method implemented in the system of FIG. 1;

FIG. 3 is a top plan view of an administrator's hand-held device showing an administrator home page for an administrator application of the hall pass system showing an option to select a name-based search and a time-based search;

FIG. 4 is a view similar to FIG. 3 showing a comprehensive page listing all hall passes administered via the administrator application controlled by the administrator's hand-held device of FIG. 1;

FIG. 5 is a view similar to FIG. 3 showing a time-based search page where an administrator is able to search for a specific hall pass by providing time parameters for an issued hall pass;

FIG. 6 is a top plan view of a teacher's hand-held device showing a teacher home page for a teacher application of the hall pass system showing three selection options;

FIG. 7 is a view similar to FIG. 6 showing an approval page resulting from the selection of one of the options from the teacher home page of FIG. 6 which enables a teacher to accept or reject a hall pass;

FIG. 8 is a view similar to FIG. 6 showing a comprehensive page listing all hall passes that need verification via the teacher application controlled by the teacher's hand-held device of FIG. 1;

FIG. 9 is a view similar to FIG. 6 showing a comprehensive page listing who is all coming to the teacher's classroom via the teacher application controlled by the teacher's hand-held device of FIG. 1;

FIG. 10 is a top plan view of a student's hand-held device showing a student home page for a student application of the hall pass system showing three selection options;

FIG. 11 is a view similar to FIG. 10 showing a pass creation page resulting from the selection of one of the options from the student home page of FIG. 11 which enables a student to create a hall pass request, provide both a destination and purpose for the hall pass, and issue the request for the hall pass;

FIG. 12 is a view similar to FIG. 10 showing a my passes page resulting from the selection of one of the options from the student home page of FIG. 10 which enables a student to view all of his or her created passes and their verification status; and

FIG. 13 is a view similar to FIG. 10 showing a bathroom pass page resulting from the selection of one of the options from the student home page of FIG. 10 which enables a student to create a bathroom hall pass along and to track how long the student was gone on the bathroom break.

Equivalent reference components point to corresponding parts throughout the several views. Unless otherwise indicated, the components shown in the drawings are proportional to each other. Wherein, the illustrations depicted are manifestations of the disclosure, and such illustrations shall in no way be interpreted as limiting the scope of the disclosure.

### DETAILED DESCRIPTION OF THE DRAWINGS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

The embodiments of the present disclosure can be implemented in manners including but not limited to computers and/or mobile devices that utilize Apple®, Android®, or Windows® operating systems. Additionally, embodiments can be implemented via web servers and other web based operating system platforms.

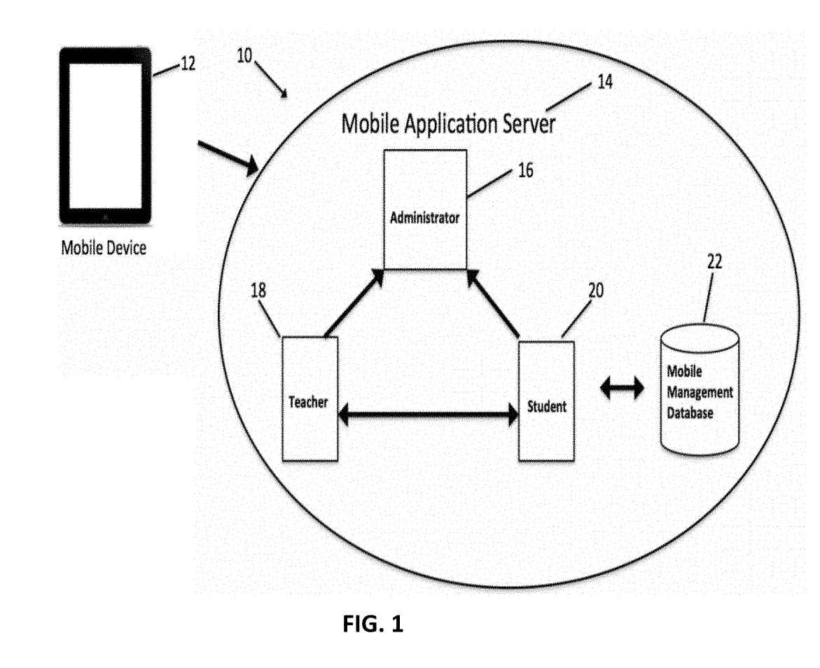

The preferred embodiment of the present disclosure is best understood by referring to FIGS. 1-13 of the drawings, like numerals being used for the like and corresponding pats of the various drawings

Referring first to FIG. 1, a digital hall pass system 10 is shown that includes a plurality of hand-held mobile devices 12 including administrator devices 16, teacher devices 18, student devices 20, and a mobile application server 14 that interacts with hand-held mobile devices 12. Mobile application server 14 includes a mobile management database 22 that stores hall pass data.

Mobile Application server 14 coordinates the issuance and administration of digital hall passes by administrators and teachers 24 using respective administrator and teacher devices 16, 18 to students using student devices 20. Also, mobile application server 14 hosts and operates digital hall pass system 10 and maintains all user service profiles. Preferably, hand-held mobile devices 12 communicate with mobile application server 14 and/or with each other over a wireless network, such as a cell phone system or/and a wi-fi network, etc.

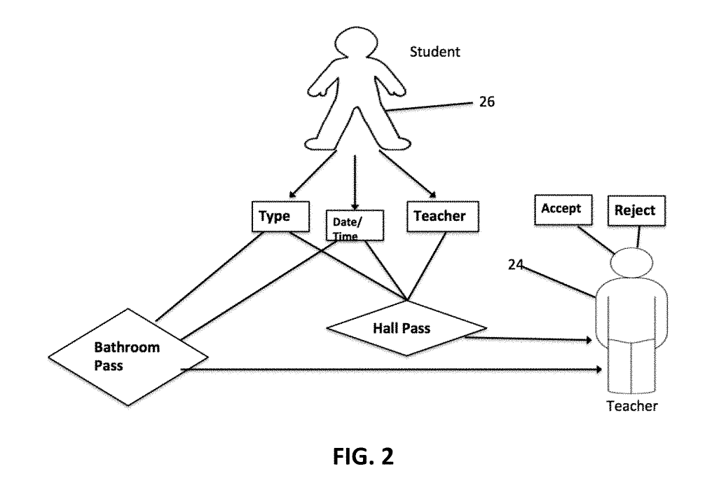

To travel from their normally assigned classroom to another room, such as another classroom, a restroom, an administrative office, etc., a student needs a hall pass to document that their travel is authorized. As shown in FIG. 2, to obtain a pass, a student 26 makes a hall pass request on student device 18, which is sent to mobile application server 14. Mobile application server 14 sends the student's hall pass request to a designated teacher's device 18. A teacher 24 may either verify or deny the student's hall pass request on their teacher device 18. The verification or denial is then sent to mobile application server 14. An administrator (not shown) is able to administer and view hall passes stored in mobile management database 22 via administrator device 16.

FIG. 2 is a block diagram of some operations of system 10 in which a student 26 makes a distinction pertaining to the type of pass and the details of the pass prior to a request of issuance of a hall pass, in accordance with a preferred embodiment of system 10. Student 26 creates a hall pass request and selects the preferences of the pass on student device 20. Once requested, the pass is sent via mobile application server 14 to mobile management database 22 (FIG. 1) where it is stored. Once stored and sent to a respective teacher device 18, the respective teacher 24 can select between to authorize or deny the student requested pass on teacher device 18.

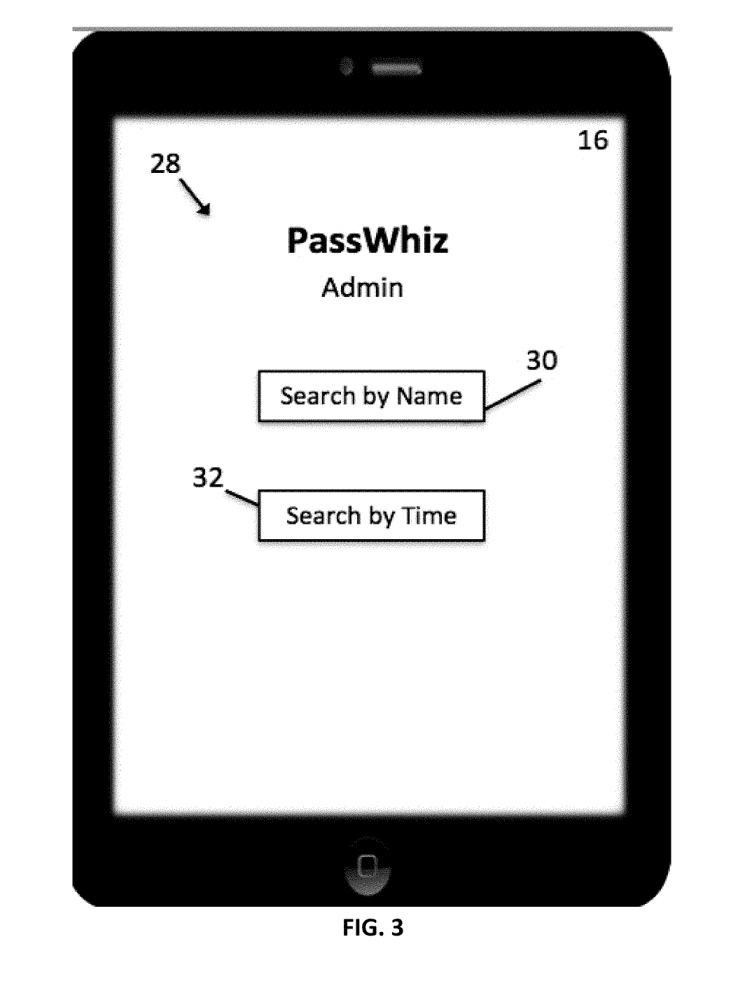

As shown in FIG. 3, system 10 includes an administrator homepage 28 that normally resides on administrator device 16 where an administrator (not shown) is able select whether to search for any issued hall pass by either the name of student 26 by selecting a name button 30 or the intended hall pass time by selecting a time button 32. In other embodiments, administration homepage 28 may contain fewer or more buttons and other components.

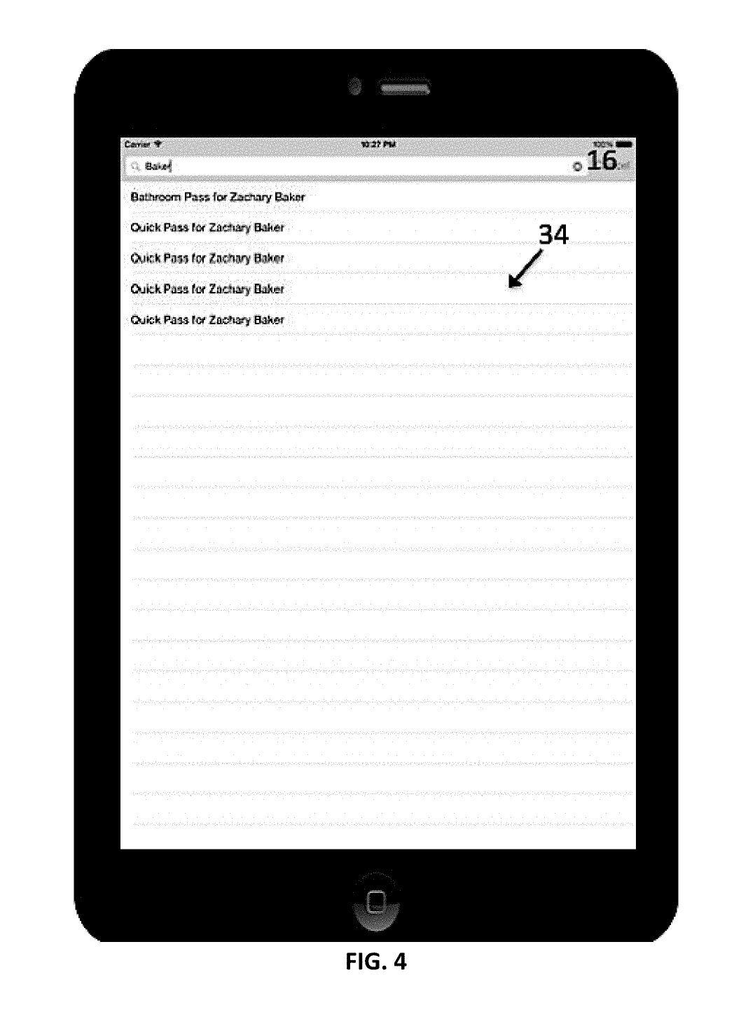

When the administrator selects name button 30 shown in FIG. 3, administrator device 16 pulls up name search page 34 shown in FIG. 4. On name search page 34, the administrator can enter a name (ex. Baker). In response, name search page 34 will query mobile management database 22 for all current passes for students having the searched name and list the results of the query and indicate the type of passed issued to the listed students. For example, if “Baker” is entered into the name search then mobile application server 14 will interact with mobile management database 22, and mobile management database 22 will return all passes issued with the name “Baker.”

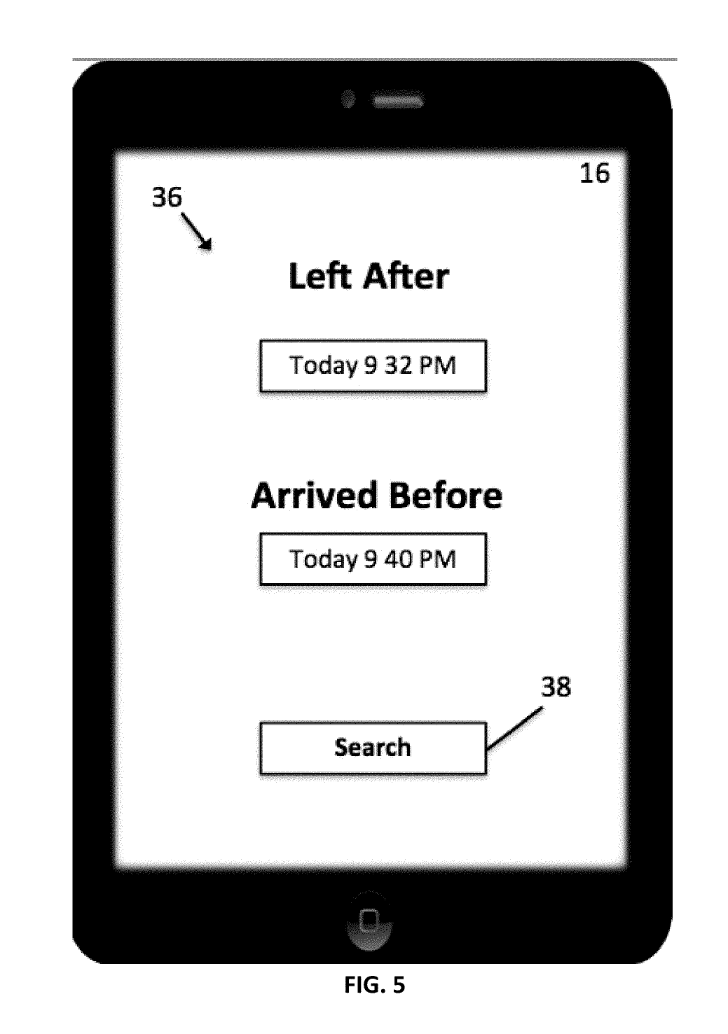

When the administrator selects time button 32 shown in FIG. 3, administrative device 16 pulls up time-based search page 36 shown in FIG. 5. On time-based search page 36 the administrator can enter both the time that student 26 left after and the time that student 26 arrived before. Upon selection of search button 38, time-based search page 36 will query mobile management database 22 for all current passes for students 26 within the provided time parameters and list the results of the query and indicate the type of pass issued to the listed students. For example, if “9:32 PM” is entered into the “left after” field and “9:40 PM” is entered into the “arrived before” field, then mobile application server 12 will interact with mobile management database 22, and mobile management database 22 will return all passes issued within the provided time parameters.

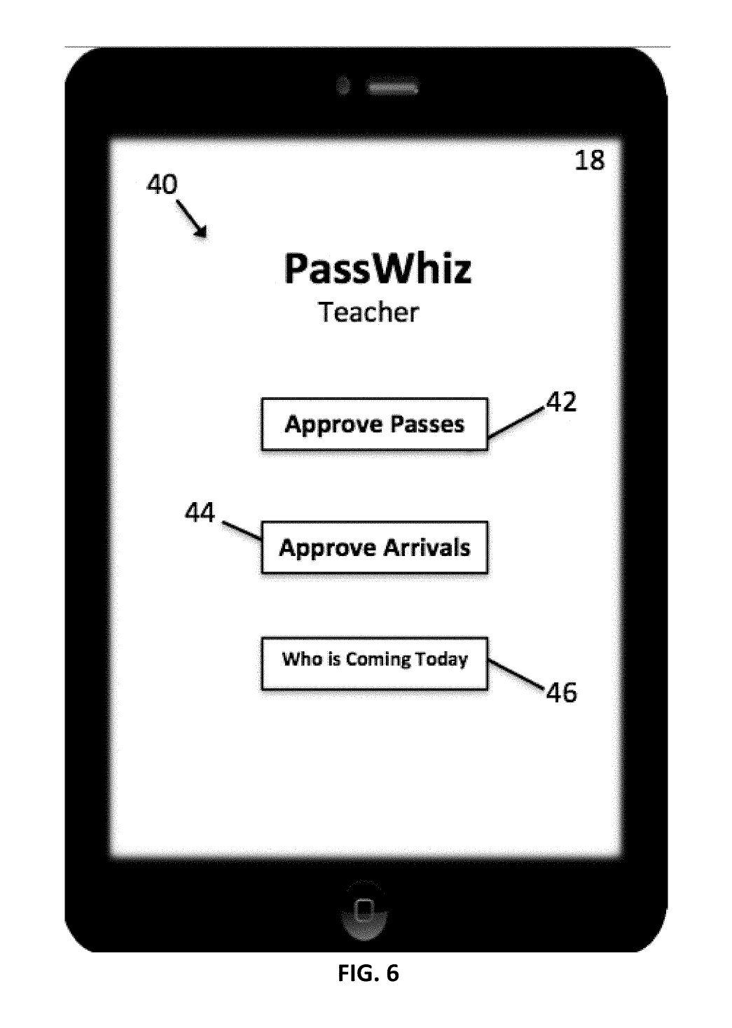

As shown in FIG. 6, system 10 includes a teacher homepage 40 that normally resides on teacher device 18 where a teacher 24 is able to select whether to approve passes requested by students assigned to that particular teacher 24 by selecting an approve passes button 42, approve the arrival of students that have that particular teacher 24 listed as a destination by selecting an approval arrival button 44, or view a comprehensive list of all student passes that are associated with that particular teacher 24 by selecting a “Who is Coming” button 46. In other embodiments, teacher homepage 40 may contain fewer or more buttons and other components.

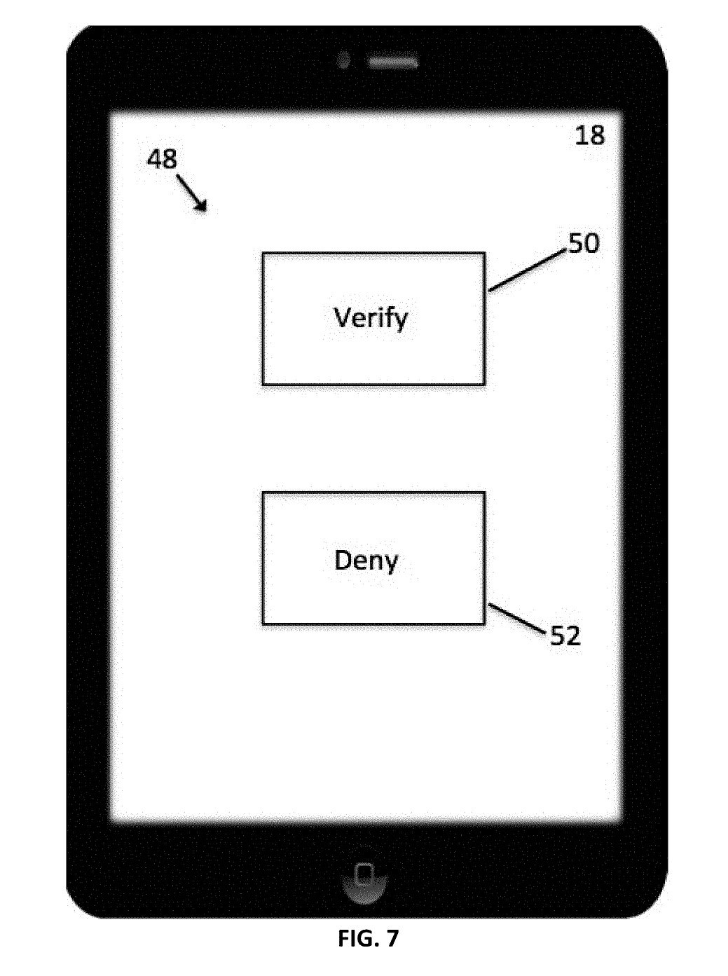

When teacher 24 selects approve passes button 42 shown in FIG. 6, teacher device 18 pulls up page 48 shown in FIG. 7 in which teacher 24 is able to verify the student's pass by selection of verify button 50 or deny the student's pass by selection of deny button 52. In response to teacher 24 selecting verify button 50, the approval of the respective student's pass is saved on mobile management database 22 so that mobile application server 14 may be able to transmit the data to both administrator device 16 and teacher device 18 and to keep track of issued passes. According to one embodiment, the name of the respective student is shown on page 48.

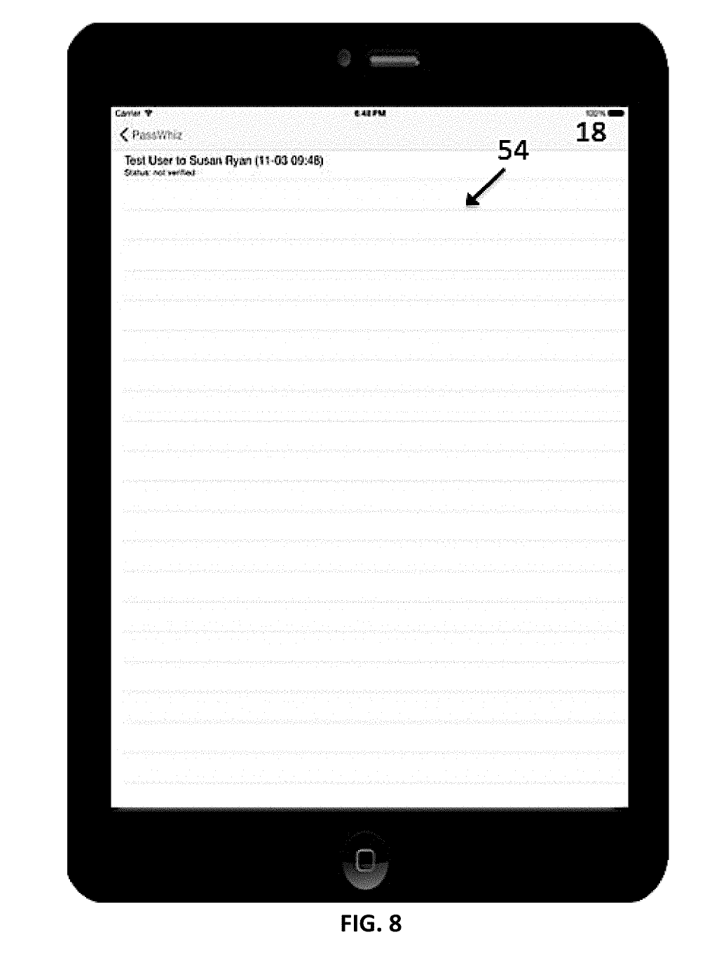

When teacher 24 selects approve arrival button 44 shown in FIG. 6, teacher device 18 pulls up page 54 shown in FIG. 8, which will query mobile management database 22 for all current passes for students that have the teacher's name specified as a destination along with whether the pass has been verified or not. Upon approval of student pass via verify button 50, the pass is stored to the mobile management database 22 and made viewable on both administrator device 16 and student device 20 via mobile application server 14.

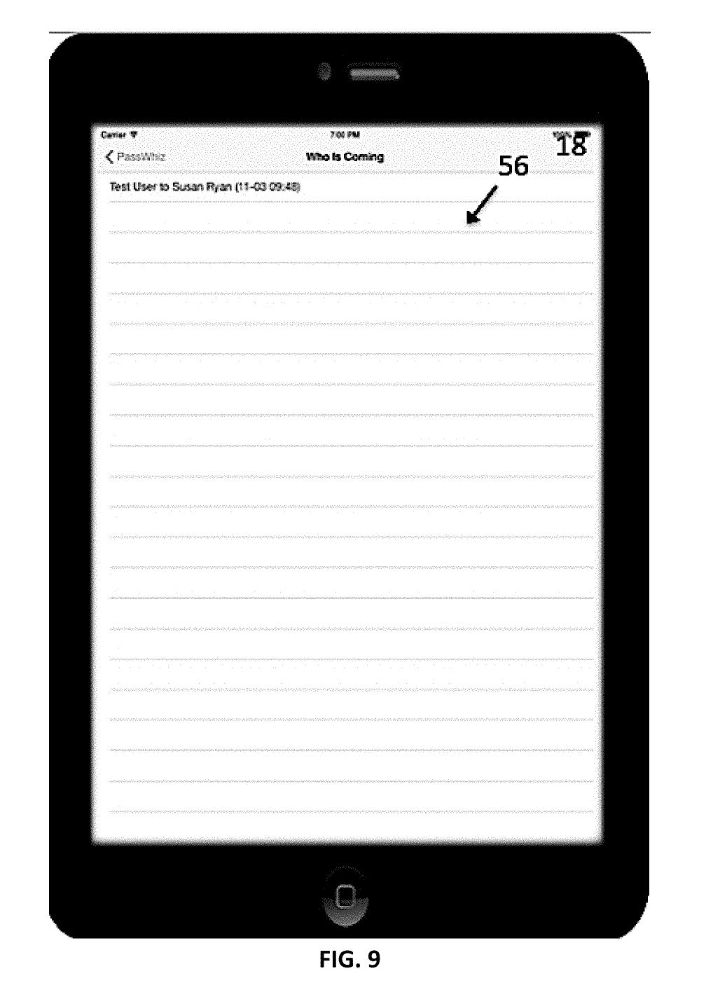

When teacher 24 selects “Who is Coming” button 46 shown in FIG. 6, teacher device 18 pulls up page 56 shown in FIG. 9, which will query mobile management database 22 for a comprehensive list of all current verified passes for students that have the name of teacher 24 specified as a destination.

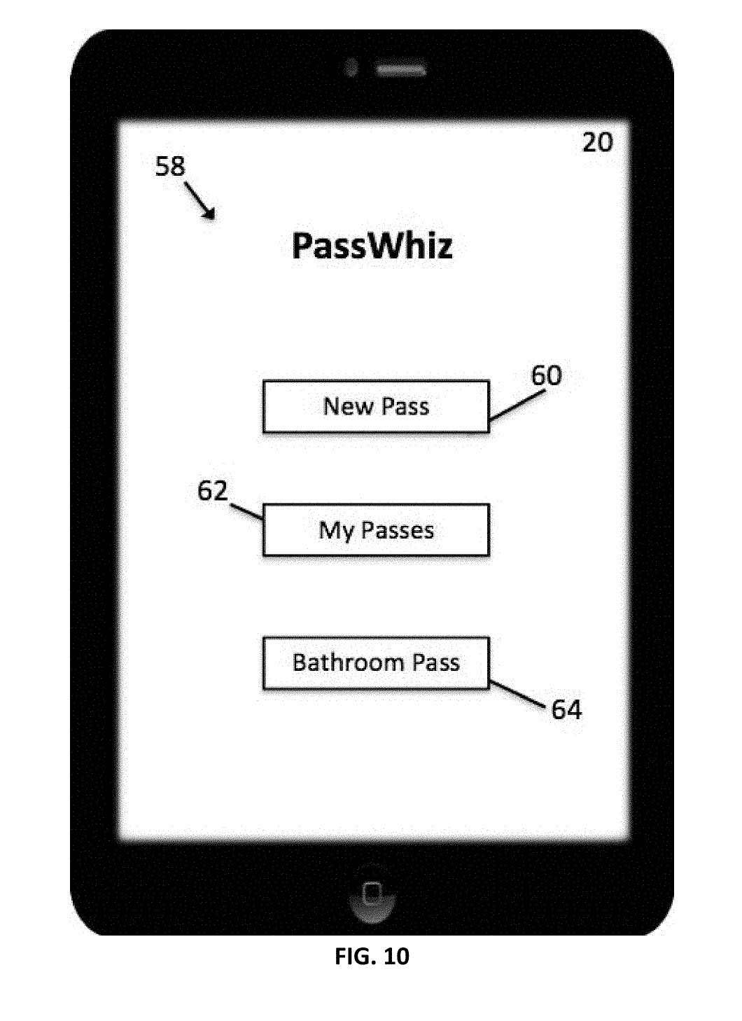

As shown in FIG. 10, system 10 includes a student homepage 58 that normally resides on student device 20 where student 26 is able to select whether to create a hall pass request by selecting new pass button 60, view all that student's created passes by selecting a my passes button 62, or create a bathroom pass by selecting bathroom pass button 64. In other embodiments, student homepage 58 may contain fewer or more buttons and other components.

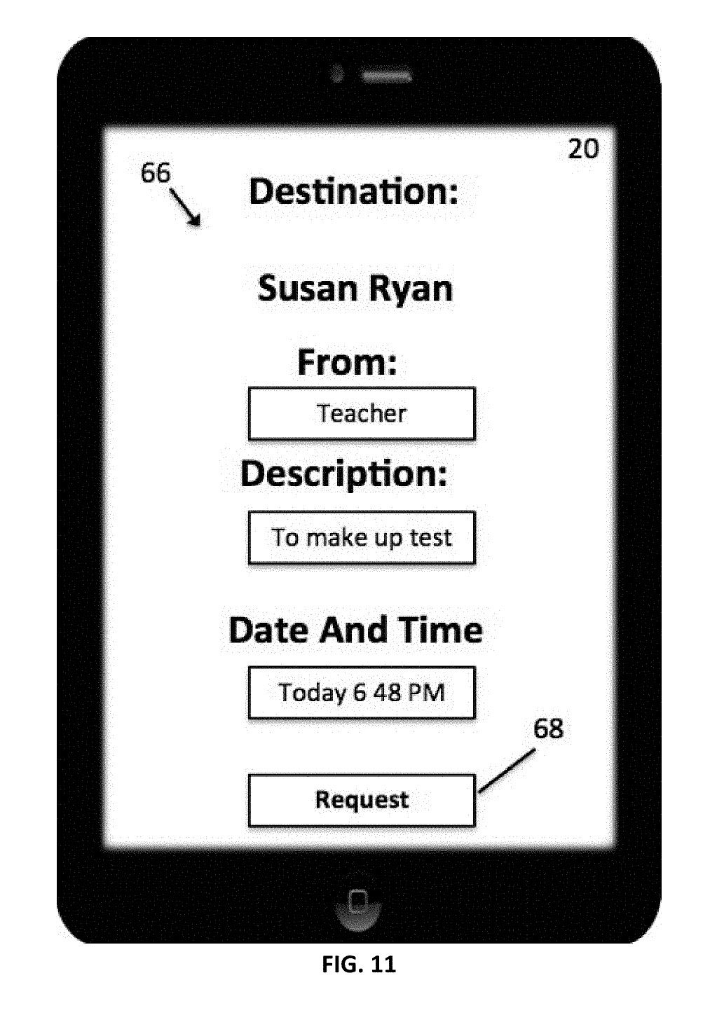

When student 26 selects new pass button 60 shown in FIG. 10, student device 20 pulls up page 66 shown in FIG. 11 in which student 26 is able to provide destination teacher 24 for which pass is intended, a description of the purpose of the pass, and the date and time that student 26 is requesting the pass. Once these fields are filled out, student 26 selects request button 68 in response to which mobile application server 14 sends a data entry comprised of the hall pass's destination, description, and date and time to mobile management database 22 where it is stored, and able to be viewed by administrator device 16 and teacher device 18.

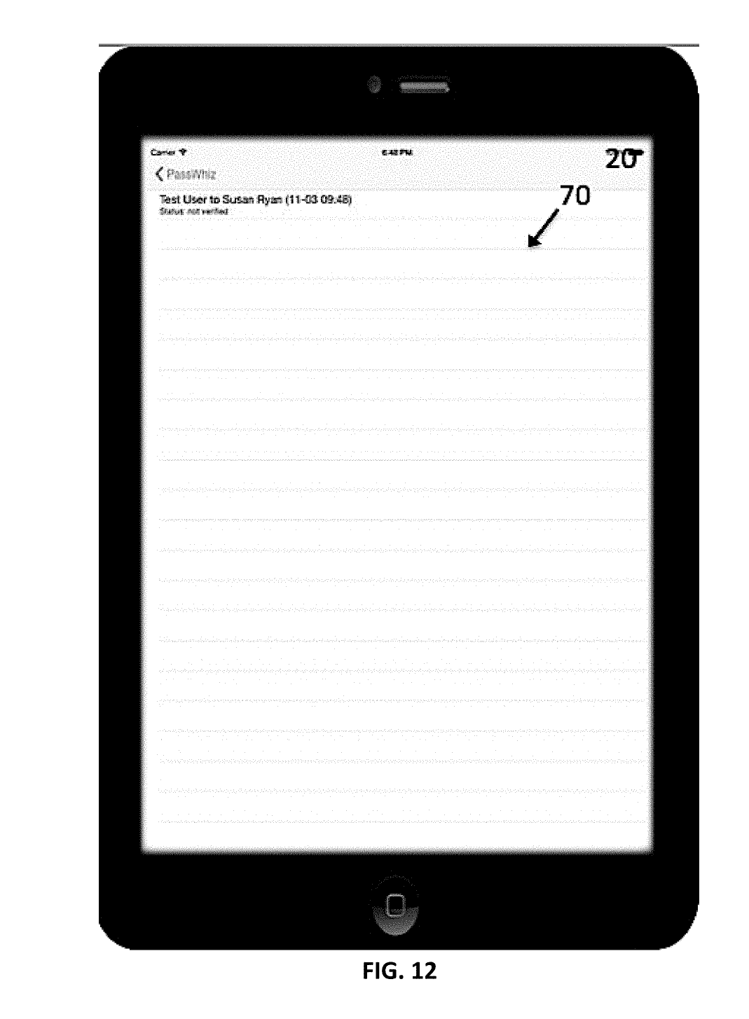

When student 26 selects my passes button 62 shown in FIG. 10, student device 20 will query mobile management database 22 for all current passes having the name of student 26. In response, student device 20 pulls up page 70 shown in FIG. 12 listing both the results of the query and the verification status of the passes of student 26.

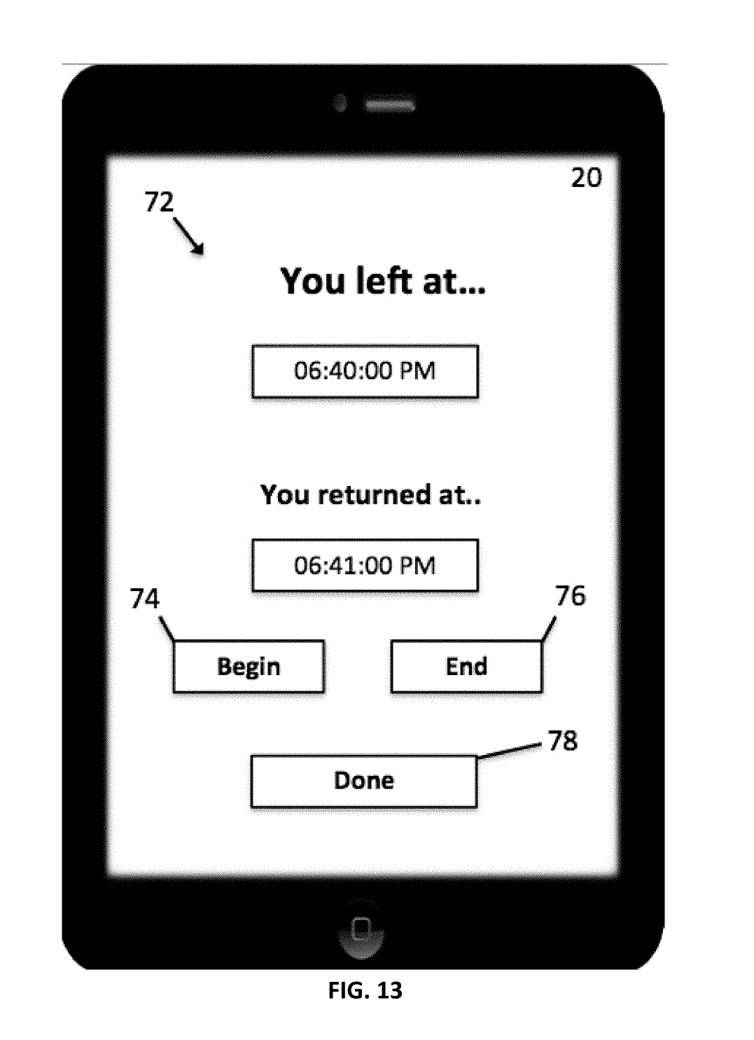

When student 26 selects bathroom pass button 64 shown in FIG. 10, student device 20 pulls up page 72 shown in FIG. 13. Student 26 is then able to begin a bathroom pass request by selecting a begin button 74, which will start a timer that will not stop until student 26 selects end button 76 upon return from the bathroom. For example, if student 26 selects the begin button 74 at “6:40:00 PM” then the bathroom pass will not be terminated until end button 76 is selected at “6:41:00 PM”. Once end button 76 is selected, student 26 selects done button 78 in which the mobile application server 14 will send student's name, the time student left for the bathroom, and the time student returned from the bathroom to mobile management database 22, which can be viewed on administrator device 16.

While this disclosure has been described as having an ideal design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

1. A system for managing a digital hall pass system comprising:
a mobile application server with a mobile management database storing hall pass data, the mobile application server receiving information and storing it in the mobile management database;
a plurality of hand-held mobile devices including
one or more student devices generating hall pass requests and sending generated hall pass requests to the mobile application server;
one or more teacher devices receiving hall pass requests from the mobile application server, the teacher devices at least one of authorizing or denying received hall pass requests, the teacher devices sending authorization or denial to the mobile application server, the teacher devices further searching and editing hall pass requests stored on the mobile management database; and
one or more administrator devices at least one of searching or editing hall pass requests stored on the mobile management database.

2. The system of claim 1, wherein the hall pass request includes at least one a student name, a teacher name, a destination, a description, a date, or a time.

3. The system of claim 1, wherein the student device searches for hall pass requests associated with that student device on the mobile management database.

4. A method for managing a digital hall pass system comprising:
creating a hall pass request using a student device;
sending the hall pass request to a mobile application server;
storing the hall pass request on a mobile management database located on the mobile application server;
sending the hall pass request to a teacher device;
authorizing or denying the hall pass request using the teacher device;
sending the authorization or denial to the mobile application server; and
storing the authorization or denial on the mobile management database.

5. The method of claim 4, further comprising the step of using the teacher device to search the mobile management database for a hall pass request.

6. The method of claim 4, further comprising the step of using the teacher device to edit a hall pass request stored on the mobile management database.

7. The method of claim 4, further comprising the step of using an administrator device to search the mobile management database for a hall pass request.

8. The method of claim 4, further comprising the step of using an administrator device to edit a hall pass request stored on the mobile management database.

9. The method of claim 4, further comprising the step of using the student device to search the mobile management database for a hall pass request.

10. The method of claim 9, further comprising a step of restricting the student device from searching for hall pass requests that were not created by the student device.
